(19) United States
(12) Patent Application Publication
(10) Pub. No.: US 2021/0070145 A1
(43) Pub. Date: Mar. 11, 2021

(54) GRID FOR TEMPERATURE CONTROL AND FAN SPEED

(71) Applicant: Byton North America Corporation, Santa Clara, CA (US)

(72) Inventors: Andre NITZE-NELSON, Pipes Canyon, CA (US); Carsten KUHOFF, Sunnyvale, CA (US)

(21) Appl. No.: 16/565,341

(22) Filed: Sep. 9, 2019

(51) Int. Cl. B60H 1/00; G06F 3/0488; G06F 3/0486; G06F 3/0484; B62D 1/04

(52) U.S. Cl. CPC B60H 1/00985; G06F 3/04883; G06F 3/0486; B62D 1/046; B60H 1/00735; B60H 1/00828; B60H 1/0065; G06F 3/04845

(57) ABSTRACT

For one embodiment, an exemplary method of controlling the climate in a vehicle includes the operations of detecting a moving of a touch from a first location to a second location on the touch screen in the vehicle, each of the first location and the second location associated with a pair of values; determining a first value and a second value of the pair of values associated with the second location on the touch screen; and adjusting the speed of at least one fan based on the first value and the temperature of at least one seating area based on the second value.

### TECHNICAL FIELD

Embodiments of the present disclosure generally relate to vehicle climate control, and more particularly relate to a grid-based user interface for simultaneously adjusting fan speeds and temperatures.

### BACKGROUND

Existing climate controls in vehicles typically use mechanical knobs, buttons or menus on a touch screen. Further, a user typically needs to use separate controls to adjust the temperature and the fan speed in a vehicle. Therefore, it would be desirable to have a single control that can simultaneously and intuitively adjust the fan speed and temperate in a vehicle.

### SUMMARY

For one embodiment, an exemplary method of controlling the climate in a vehicle includes the operations of detecting a moving of a touch from a first location to a second location on the touch screen in the vehicle, each of the first location and the second location associated with a pair of values; determining a first value and a second value of the pair of values associated with the second location on the touch screen; and adjusting the speed of at least one fan based on the first value and the temperature of at least one seating area based on the second value.

### BRIEF DESCRIPTION OF THE DRAWINGS

The figures of the accompanying drawings provide examples of embodiments. Like references indicate similar elements.

FIG. 1 illustrates an example of a system for controlling the climate in a passenger compartment of a vehicle in accordance with an embodiment.

FIG. 2 is a data flow diagram illustrating an example process of controlling the climate in a passenger compartment of a vehicle in accordance with an embodiment.

FIG. 3 illustrates an example touch screen in accordance with one embodiment.

FIGS. 4A-4B illustrate example touch screens in accordance with an embodiment.

FIG. 5 illustrates an example touch screen when the auto option is enabled.

FIG. 6 illustrates an example touch screen where a control graphic is being dragged in accordance with an embodiment.

FIG. 7 illustrates an example of a process of controlling the climate in a passenger compartment of a vehicle in accordance with an embodiment.

### DETAILED DESCRIPTION

As used herein, a vehicle can be a road vehicle (electric or non-electric), such as an automobile, a van, a truck, and a bus; a train; an aircraft, such as an airplane; a spacecraft; or any machinery that transports people or things.

For various embodiments, a grid-based interface on a touch screen is provided in a vehicle, for use in controlling the climate in the vehicle. A control graphic on the touch screen can be dragged from one location to another. A pair of values associated with the new location where the dragging ends can be used to simultaneously adjust a fan speed and a temperature for at least one seating area in the vehicle.

For one embodiment, an exemplary method of controlling the climate in the vehicle includes the operations of detecting a moving of a touch from a first location to a second location on the touch screen in the vehicle, each of the first location and the second location associated with a pair of values; determining a first value and a second value of the pair of values associated with the second location on the touch screen; and adjusting the speed of at least one fan based on the first value and the temperature of at least one seating area based on the second value.

For one embodiment, the touch screen includes a touch-sensitive rectangle touch interface with multiple equal-sized grids, and each grid is associated with a pair of integer values, with one value representing a fan speed, and the other value representing a temperature. Both the first location and the second location corresponds to a grid on the rectangle touch interface. The rectangle touch interface can be a square-shaped touch interface. The multiple grids can be visible or invisible on the rectangle touch interface.

For one embodiment, the control graphic can be dragged along with the moving of a touch from the first location to the second location. The control graphic can be any geometric shape, for example, a circle, a rectangle, or a triangle. A pair of indicators can be dragged along with the control graphic, with one indicator indicating the fan speed and the other indicator indicating the temperature. Both can be numerical indicators and can appear outside the control graphic as the control graphic is being dragged, and appear inside the control graphic when the dragging ends.

For one embodiment, the first location corresponds to a grid on the rectangle interface, and the second location corresponds to another grid on the rectangle touch interface. When the center of the control graphic falls within a grid, the control graphic is considered as corresponding to the grid. The rectangle touch interface can be divided into a number of zones, including a hot zone, an intermediate zone and a code zone. Each zone can be the same size or a different size, can include a number of grids, and can be associated with a different color. The control graphic can change its color as it is being dragged vertically from one zone to another.

For one embodiment, a color gradient can be created from a color corresponding to each zone. The control graphic changes its color from one shade in a color gradient to another shade in the color gradient as it is being dragged vertically across each grid. The control graphic also changes its size as it is being dragged horizontally across each grid, with the size indicating the magnitude of the fan speed.

For one embodiment, the touch screen can be positioned within a steering wheel in front of a driver seat of the vehicle, between the driver seat and a front passenger seat in the vehicle, or in front of each back passenger seat in the vehicle. When positioned within the steering wheel, the touch screen can include a menu or another mechanism to disable or enable a synch feature. The synch feature, when engaged, controls the entire vehicle at once. When the sync feature is disengaged, the vehicle is in a non-sync mode, and each seat occupant can control the temperature and fan speed in his or her own seating area.

The above summary does not include an exhaustive list of all aspects of the present invention. It is contemplated that the invention includes all systems, computer media, and methods that can be practiced from all suitable combinations of the various aspects summarized above, and also those disclosed in the Detailed Description below.

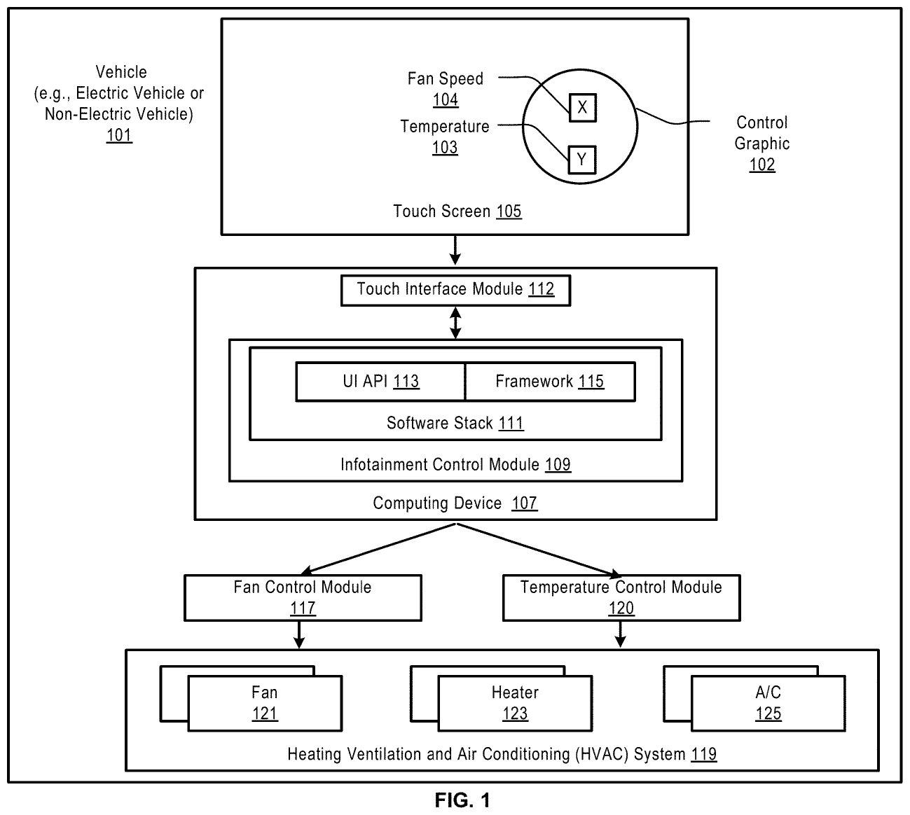

FIG. 1 illustrates an example of a system for controlling the climate in a passenger compartment of a vehicle in accordance with an embodiment.

As shown in FIG. 1, the example system includes a computing device 107, which can be installed under a dashboard in a vehicle 101. The computing device 107 can be a system on a chip (SoC), a single package with multiple chips integrated onto a motherboard, or a single device multiple SOCs integrated together.

For one embodiment, the computing device 107 can include multiple virtual machines managed by a hypervisor. Each virtual machine can have a different guest operating system installed thereon. The multiple virtual machines can include a Linux-like operating system, such as Android (from Google of Mountain View, Calif.); and a Unix-like real-time operating system, for example, the QNX® operating system (from Blackberry Limited of Waterloo, Canada). The Unix-like real-time operating system can run driving-critical applications.

For one embodiment, an infotainment control module 109 can run in an Android operating system installed in one of the virtual machines. The infotainment control module 109 can include a software stack 111 comprising a display framework 115 (e.g., an Android Display Framework), and a user interface API 113.

The example system further includes a touch screen 105 that is connected to the computing device 107 using a physical cable (e.g., a HDMI or DVI cable), a wireless connection, or a Bluetooth connection. For one example, the touch screen 105 can be a glass panel covered with a conductive layer and a resistive metallic layer. The two layers can be held apart by spacers. An electrical current can run through the two layers when the example system is operational. When a user touches the touch screen 105 using a finger or a stylus, the two layers can make contact at the touch point (i.e. point of touching), causing a change in the electrical field.

For one embodiment, the display framework 115 and the user interface API 113 can be configured to render images and graphics on a touch-sensitive rectangle touch interface. In this example, a two-dimensional Cartesian coordinate system can be rendered and displayed on the rectangle touch interface. The Cartesian coordinate system may include only the first quadrant that is divided into multiple equal-sized grids arranged rows and columns. Each grid can be associated with a pair of integers.

For one embodiment, one value of the pair of values associated with each grid can represent a fan speed, and the other value can represent a temperature. The value representing the fan speed can be either the X value or the Y value associated with each grid. Similarly, the value representing the temperature can also be a X value or Y value associated with the grid.

The rectangle touch interface can be a square-shape touch interface. As shown in the FIG. 1, a control graphic 102 can be rendered and displayed on the rectangle touch interface on the touch screen 105. Although illustrated herein as a circular graphic, the controlling graphic 02 can be one of a number of geometric shapes, for example, a square or a triangle. The control graphic 102 can include a pair of numerical indicators, with one indicator 103 for indicating the temperature and the other indicator 104 for indicating the fan speed.

The control graphic 102 can be touched and dragged using a finger or a stylus from one location to another. The UI API 113 can include a number of touch events for detecting the touching and dragging of the control graphic 102. For example, a touchStart event can be generated when a finger is placed on the control graphic 102, a touchMove event can be generated when a finger drags the control graphic 102, and a touchEnd event can be generated when a finger is removed from the control graphic 102.

The touching and dragging on the touch interface can cause changes in the electric field created by an electrical current running through the conductive layer and a resistive metallic layer of the touching screen 105. A touch interface module 112 can detect the changes in the electrical field, and, in response to the changes, can calculate coordinates of a target location which the control graphic 102 is moved to in accordance with definitions in the user interface API 113.

The touch interface module 112 can subsequently translate the X coordinate into information that the Linux-like operating system (e.g., Android operating system) can understand. The Linux-like operating system can invoke the user interface API 113 to interpret the translated information based on definitions in the user interface API 113, and to convert the translated information into one or more parameters. The parameters can be transmitted to a fan control module 117, which converts the parameters into electrical signals, and sends the electrical signals to a number of motors coupled to the one or more electric fans (e.g., fan 121) in a HVAC system 119 in the vehicle 101.

The touch interface module 112 can similarly translate the Y coordinate into information for controlling one or more heaters (e.g., heater 123). The translated information can be converted into one or more parameters based on definitions in the user interface API 113. The parameters can be transmitted to a temperature control module 120, which converts the parameters into electrical signals, and sends the signals to one or more heaters (e.g., heater 123) and one or more air conditioners (A/C) (e.g., A/C 125).

For one embodiment, each A/C in the HVAC system 119 can include a compressor, which pressurizes refrigerant along with blend door actuators to direct air flow. One or more actuators in the HVAC system 119 can be used to control air temperature by mixing the hot air from the heaters 123 and the cold air from the A/C 125.

For one embodiment, the climate control in the vehicle 101 can be performed in an automatic (auto) mode, in which the passenger compartment temperature and humidity is maintained at a preset level, regardless of the outside weather conditions. In a non-automatic mode, a user can set the temperature by dragging the control graphic 102 to a desire location on the touch screen 105. The dragging can cause the HVAC system 119 to adjust the air temperature in the compartment of the vehicle to a desired level by blending fresh air, warm air from the heater 123 and cool air from an evaporator of the A/C 125.

In one implementation, in a non-sync mode, the vehicle 101 can include a number of defined seating areas. Each user (driver or passenger) can adjust the temperature of the seating area in which he or she is seated. Each zone has a separate climate control sensor that reads the current temperature of the specified seating area.

In a sync mode, the vehicle 101 can regulate the entire air system within the passenger compartment. The HVAC 119 can regulate the speed of one or more fans, and engagement of the air conditioning compressor.

For one embodiment, the synch mode can be enabled or disabled through a touch screen (e.g., the touch screen 105) positioned within the steering wheel of the vehicle 105. In the sync mode, climate control settings on touch screens for passengers are linked to the climate control settings on the touch screen for the driver.

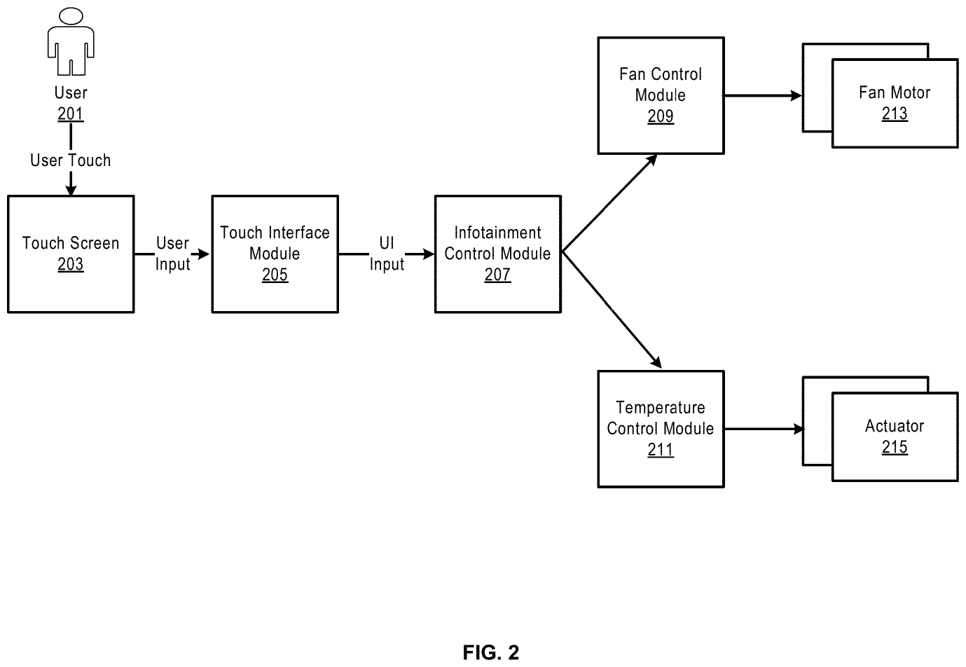

FIG. 2 is a data flow diagram illustrating an example process of controlling the climate in a passenger compartment of a vehicle in accordance with an embodiment.

As shown in FIG. 2, a user 201 can drag a control graphic as shown in FIG. 1 on a touch a touch screen 203. A touch interface module 205 can detect the dragging and determine coordinates of a location where the control graphic has been moved to in accordance with definitions in a user interface API (e.g., a user interface API in an Android display framework) installed in an infotainment control module 207.

The infotainment control module 207 can receive the coordinates. The user interface API in the infotainment control module 207 can convert the X coordinate into one or more parameters for use by a fan control module 207 to adjust the speed of a fan using one or more fan motors 213. The user interface API can covert the Y coordinate into one or more parameters for use by a temperature control module 211 to adjust the temperature of a seating area using one or more actuator 215.

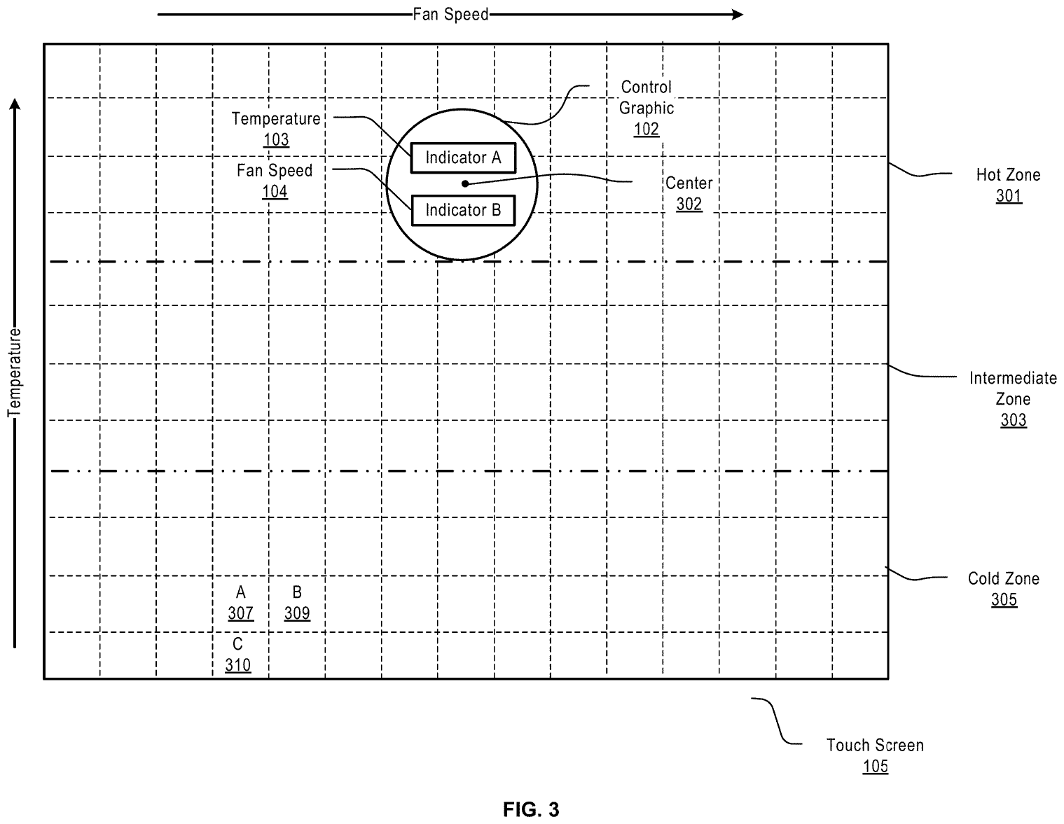

FIG. 3 illustrates an example touch screen in accordance with one embodiment. The example touch screen 105 can include a touch interface programmed by one or more touch drivers, which can capture screen pixel coordinates.

For one embodiment, the coordinates of each pixel on the touch interface can fall into the first quadrant of a two-dimensional Cartesian coordinate system. The touch interface can be divided into multiple equal-sized grids. The touch drivers can program the touch interface such that all points/pixels in a grid shares a common X coordinate and a common Y coordinate. The X coordinates for two neighboring grids can be different by a predetermined value, which can be an integer (e.g., 1), or a fraction (e.g., 0.5). Similarly, the Y coordinates for two vertically neighboring grids can be different by the same predetermined value or a different predetermined value.

For example, if the X coordinate for grid A 307 is 3, then the X coordinate for grid B 309 would be 4. If the Y coordinate of grid A 307 is 1, the Y coordinate of grid C 310 would be 0. Therefore, all points in grid C 310 would share the same coordinates (3, 0), and all point in grid B 309 would share the same coordinates (4, 1).

For one embodiment, each of the X coordinates of the grids can indicate a desired speed of a fan while each of the Y coordinates of the grids can indicate a desired temperate in a particular seating area or in the whole passenger competent of the vehicle.

As further shown in FIG. 3, the control graphic 102 can be associated with indicator A 103 for indicating a desired temperature and indicator B 104 for indicating a desired fan speed. The value for each indicator corresponds to the coordinates of the grid which the center point 302 of the control graphic 102 falls in.

The control graphic 102 can be dragged to another grid (a target grid) together with its associated indicators 103 and 104. The dragging can cause a HVAC system (e.g., the HVAC system 119 in FIG. 1) to adjust the speed of at least one fan or the temperature of at least one seating area in accordance with the desired values as indicated by the coordinates of the target grid.

For one embodiment, the touch interface on the touch screen 105 can be divided into a number of zones, for example, a hot zone 301, an intermediate zone 303, and a cold zone 305. Each zone can include a subset of the grids, and can be associated with a corresponding color. For example, the hot zone 301 can be associated with a red color, the intermediate zone 303 can be associated with an orange color, and the cold zone 305 can be associated with a blue color.

The color associated with each zone is displayed by the control graphic 102 and/or the indicators 103 and 104 when the control graphic 102 is dragged into the zone.

In FIG. 3, while the control graphic 102 is being dragged from the hot zone 301 to into the intermediate zone 303, the color and/or the associated indicators 103 and 104 can change from red to orange. For one embodiment, the color of the control graphic 102 can change as the center 302 of the control graphic 102 passes the dividing line between the two zones 301 and 303. For one embodiment, the grid lines and the zone dividing lines can be logical lines which are invisible to users.

As the control graphic 102 is being dragged from right to left horizontally, the Y coordinate of each grid passed by the center 302 of the control graphic 102 may stay the same while the X ordinate of the grid may increase. For one embodiment, the size of the control graphic 102 can change accordingly as the values of the X coordinates change.

For one embodiment, the size of the control graphic 102 may get smaller as the control graphic 102 is being dragged horizontally from right to left, and get larger as the control graphic 102 is being dragged from left to right. If the control graphic 102 is being dragged diagonally across a dividing line between zones, both the size and the color of the control graphic 102 will change.

For an alternative embodiment, each zone can be associated with a color gradient. For example, the hot zone 301 can be associated with a red color gradient, the intermediate zone 303 can be associated with an orange color gradient, and the cold zone 305 can be associated with a blue color gradient. Each grid in a column within a zone can correspond to a shade in a corresponding color gradient for the zone. The control graphic 102 can change its color from one shade to another in a color gradient as the color graphic 102 is being dragged vertically across each grid.

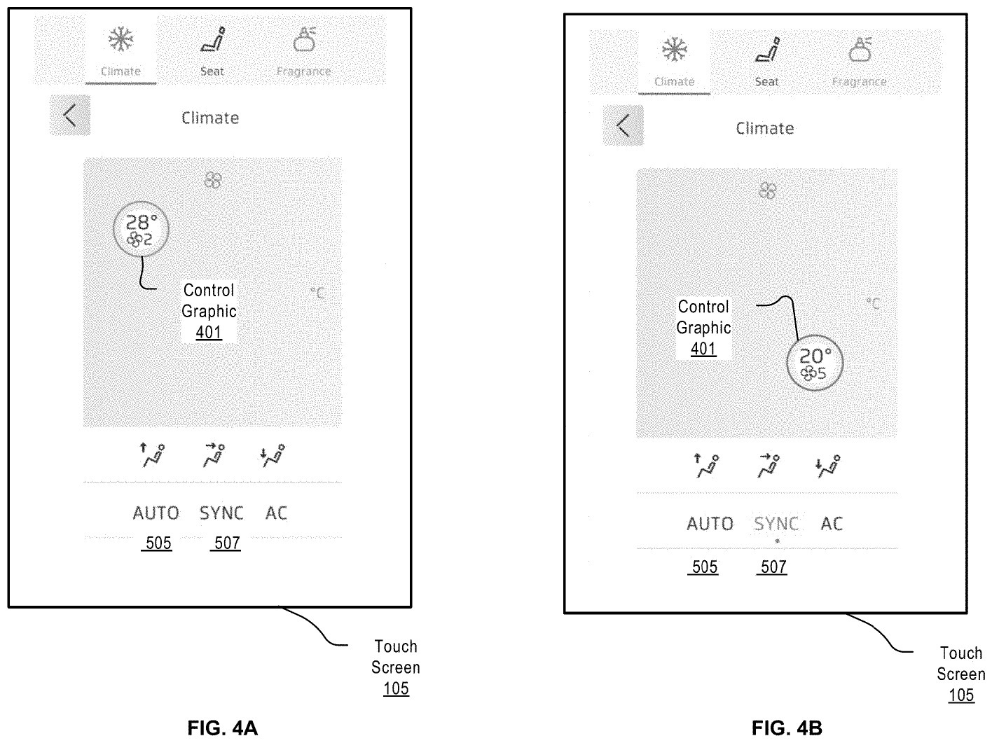

FIGS. 4A-4B illustrate example touch screens in accordance with an embodiment.

The touch screen 105 in the figures can be positioned within a steering wheel, and therefore can have a sync feature 507 in addition to the auto feature 505. The sync feature 507, when engaged, would put the vehicle into a synch mode, which allows the climate of the entire vehicle to be controlled through one touch screen. When the sync feature 507 is disabled, the vehicle would be in a non-sync mode, and each seat occupant can control his or her own temperature and fan speed.

For example, in the non-sync mode, a front seat passenger controls the HVAC from a touch screen between the driver seat and the front passenger seat. Back seat passengers control the HVAC from the touch screens behind the front seats. The driver controls the HVAC from the touch screen positioned within the steering wheel.

The sync feature can be engaged or enabled either by pressing the word “Synch” on a touch screen or through the use of a pull down menu (i.e. a Quick Access feature). There can be a solid bar that indicates Synch, and two side-by-side smaller bars that indicate Non-Synch. For one embodiment, the sync feature is available only in the touch screen positioned within the steering wheel.

For one embodiment, when the driver moves the control graphic 401 up and down, the temperature goes up and down, and the control graphic 401 changes color from blue (cold) to hot (red). When the driver moves the control graphic from left to right, the fan speed increases and the circle gets larger.

As illustrated in FIG. 4A, a control graphic 401 shows a temperature of 28° and a fan speed of 2. FIG. 4B shows that the control graphic 401 has been dragged rightwards and downwards, and therefore the control graphic 401 at the new location has a temperature of 20° and a fan speed of 5.

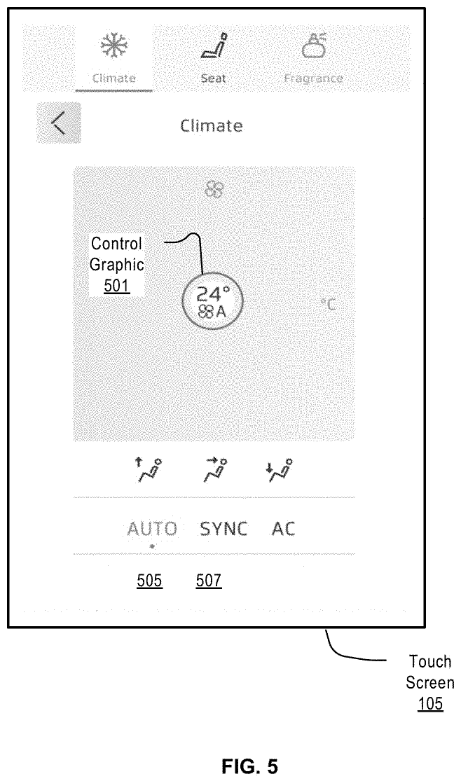

FIG. 5 illustrates an example touch screen when the auto feature 505 is enabled. As shown in FIG. 5, a control graphic 501 shows a letter “A”, which indicates that the auto feature is enabled.

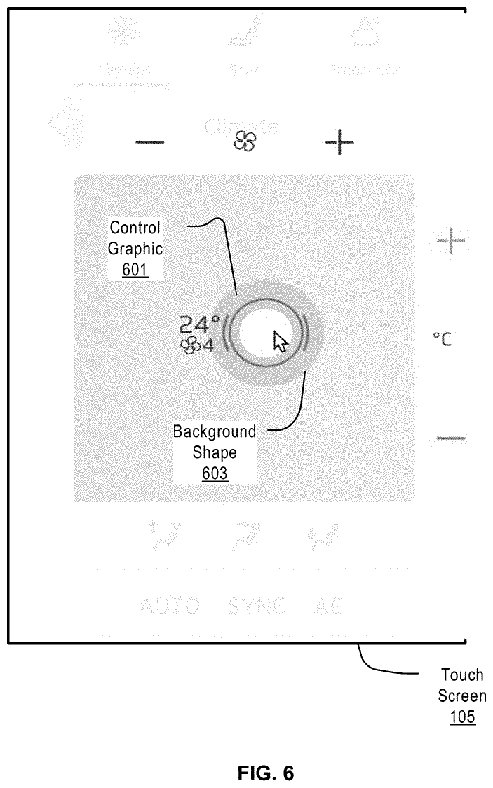

FIG. 6 illustrates an example touch screen where a control graphic 601 is being dragged in accordance with an embodiment. As shown, while the control graphic 601 is being dragged, the temperature indicator and the fan speed indicator appear outside the control graphic 601. The size of the control graphic 601 can also change as it is dragged upwards or downwards.

For one embodiment, a background shape 603 matching the shape of the control graphic 601 can be used to indicate the size change of the control graphic 601. In this example, the background shape 603 is a circular shape, which can keep shrinking as the control graphic 601 is being dragged downwards, or keep expanding as the control graphic 601 is being dragged upwards.

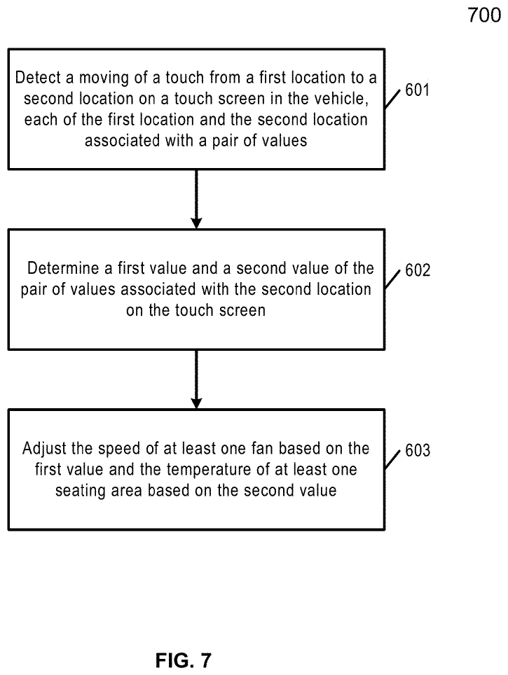

FIG. 7 illustrates an example of a process 700 of controlling the climate in a passenger compartment of a vehicle in accordance with an embodiment.

Process 700 may be performed by processing logic which may include software, hardware, or a combination thereof. For example, process 700 may be performed by one or more modules, such as the touch interface module 112, the infotainment module 107 and the fan control module 117 and the fan control module 120 as described in FIG. 1.

Referring back to FIG. 7, in operation 701, the processing logic detects a moving of a touch from a first location to a second location on a touch screen in the vehicle, each of the first location and the second location associated with a pair of values. In operation 703, the processing logic determines a first value and a second value of the pair of values associated with the second location on the touch screen. In operation 705, the processing logic adjusts the speed of at least one fan based on the first value and the temperature of at least one seating area based on the second value.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable one to make or use the methods, systems, and apparatus of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A computer-implemented method of controlling the climate in a passenger compartment of a vehicle, comprising:
detecting a moving of a touch from a first location to a second location on a touch screen in the vehicle, each of the first location and the second location associated with a pair of values;
determining a first value and a second value of the pair of values associated with the second location on the touch screen; and
adjusting the speed of at least one fan based on the first value and the temperature of at least one seating area based on the second value.

2. The method of claim 2, wherein the touch screen includes a touch-sensitive rectangle touch interface corresponding to the first quadrant and the fourth quadrant in a two-dimensional Cartesian coordinate system, wherein the rectangle touch interface includes a plurality of equal-sized grids, each of the plurality of grids being associated with a pair of integer values, with one value representing a fan speed, and the other value representing a temperature.

3. The method of claim 2, wherein each of the first location and the second location is one of the plurality of grids.

4. The method of claim 3, wherein a control graphic is dragged along with the moving of the touch from the first location to the second location.

5. The method of claim 4, wherein the center of the control graphic falls within a first grid corresponding to the first location prior to the dragging, and falls within a second grid corresponding to the second location after the dragging.

6. The method of claim 4, wherein the control graphic changes its color as it is being dragged vertically from a first of a plurality of pre-determined zones on the rectangle interface to a second of the plurality of predetermined zones, each zone corresponding to a color.

7. The method of claim 8, wherein the control graphic changes its color from a first shade in a color gradient to a second shade in the color gradient as it is being dragged vertically across each of the plurality of grids, wherein the color gradient is created from a color corresponding to one of the plurality of zones.

8. The method of claim 4, wherein the control graphic changes its size as it is being dragged horizontally across each of the plurality of grids, the size indicating the magnitude of the fan speed.

9. The method of claim 4, wherein the control graphic is one of a plurality of geometric shapes, including a circle, a rectangle, and a triangle, wherein the control graphic further includes a first indicator for indicating the fan speed, and a second indicator for indicating the temperature.

10. The method of claim 9, wherein the first indicator and the second indicator appear outside the control graphic as the control graphic is being dragged, and appear inside the control graphic when the dragging ends.

11. The method of claim 1, wherein the touch screen is positioned within a steering wheel in front of a driver seat of the vehicle, between the driver seat and one of one or more front passenger seats in the vehicle, or in front of one of a plurality of back passenger seats in the vehicle.

12. A non-transitory machine-readable medium having instructions stored therein, which when executed by a processor, cause the processor to perform operations, the operations comprising:
detecting a moving of a touch from a first location to a second location on a touch screen in the vehicle, each of the first location and the second location associated with a pair of values;
determining a first value and a second value of the pair of values associated with the second location on the touch screen; and
adjusting the speed of at least one fan based on the first value and the temperature of at least one seating area based on the second value.

13. The non-transitory machine-readable medium of claim 12, wherein the touch screen includes a touch-sensitive rectangle touch interface corresponding to the first quadrant and the fourth quadrant in a two-dimensional Cartesian coordinate system, wherein the rectangle touch interface includes a plurality of equal-sized grids, each of the plurality of grids being associated with a pair of integer values, with one value representing a fan speed, and the other value representing a temperature.

14. The non-transitory machine-readable medium of claim 12, wherein each of the first location and the second location is one of the plurality of grids.

15. The non-transitory machine-readable medium of claim 14, wherein a control graphic is dragged along with the moving of the touch from the first location to the second location.

16. The non-transitory machine-readable medium of claim 15, wherein the center of the control graphic falls within a first grid corresponding to the first location prior to the dragging, and falls within a second grid corresponding to the second location after the dragging.

17. The non-transitory machine-readable medium of claim 15, wherein the control graphic changes its color as it is being dragged vertically from a first of a plurality of pre-determined zones on the rectangle interface to a second of the plurality of predetermined zones, each zone corresponding to a color.

18. The method of claim 17, wherein the control graphic changes its color from a first shade in a color gradient to a second shade in the color gradient as it is being dragged vertically across each of the plurality of grids, wherein the color gradient is created from a color corresponding to one of the plurality of zones.

19. The non-transitory machine-readable medium of claim 15, wherein the control graphic changes its size as it is being dragged horizontally across each of the plurality of grids, the size indicating the magnitude of the fan speed.

20. A data processing system, comprising:
a processor; and
a memory coupled to the processor to store instructions, which when executed by the processor, cause the processor to perform operations, the operations including
detecting a moving of a touch from a first location to a second location on a touch screen in the vehicle, each of the first location and the second location associated with a pair of values,
determining a first value and a second value of the pair of values associated with the second location on the touch screen, and
adjusting the speed of at least one fan based on the first value and the temperature of at least one seating area based on the second value.
